(19) United States
(12) Patent Application Publication
(10) Pub. No.: US 2023/0057839 A1
(43) Pub. Date: Feb. 23, 2023

(54) IMAGE FORMING APPARATUS

(71) Applicant: KYOCERA Document Solutions Inc., Osaka (JP)

(72) Inventor: Toshimitsu Morimoto, Osaka (JP)

(21) Appl. No.: 17/885,893

(22) Filed: Aug. 11, 2022

(30) Foreign Application Priority Data
Aug. 19, 2021 (JP) 2021-134387

(51) Int. Cl. G06F 3/12

(52) U.S. Cl. CPC G06F 3/1238; G06F 3/1222

(57) ABSTRACT

An image forming apparatus includes a usage frequency determining unit and a security level managing unit. The usage frequency determining unit is configured to determine usage frequencies of respective time zones on the basis of an access log of users to this image forming apparatus. The security level managing unit is configured to determine security levels of the respective time zones on the basis of the usage frequencies, and automatically set the determined security level of each of the time zones when the time zone comes. Further, the security level managing unit sets the higher security level for the lower usage frequency.

### CROSS-REFERENCE TO RELATED APPLICATIONS

This application relates to and claims priority rights from Japanese Patent Application No. 2021-134387, filed on Aug. 19, 2021, the entire disclosures of which are hereby incorporated by reference herein.

### BACKGROUND

### 1. Field of the Present Disclosure

The present disclosure relates to an image forming apparatus.

### 2. Description of the Related Art

An image forming apparatus collectively sets setting values of predetermined plural function setting items in accordance with a specified security level. Such security level is usually set by a specific user such as administrator.

In general, when the security level gets high, security risk is decreased but usability is also decreased. As mentioned, the security level is fixed as a level set by the specific user and can not be changed by another normal user, and therefore it can not be changed frequently and the set security level may not be suitable to security risk and usability.

### SUMMARY

An image forming apparatus according to an aspect of the present disclosure includes a usage frequency determining unit and a security level managing unit. The usage frequency determining unit is configured to determine usage frequencies of respective time zones on the basis of an access log of users to this image forming apparatus. The security level managing unit is configured to determine security levels of the respective time zones on the basis of the usage frequencies, and automatically set the determined security level of each of the time zones when the time zone comes. Further, the security level managing unit sets the higher security level for the lower usage frequency.

These and other objects, features and advantages of the present disclosure will become more apparent upon reading of the following detailed description along with the accompanied drawings.

### BRIEF DESCRIPTION OF THE DRAWINGS

FIG. 1 shows a diagram that indicates a configuration of an image forming system that includes an image forming apparatus according to an embodiment of the present disclosure;

FIG. 2 shows a block diagram that indicates configurations of the image forming apparatus and a user terminal apparatus shown in FIG. 1;

FIG. 3 shows a diagram that indicates an example of a time zone with a low usage frequency on days of week; and

FIG. 4 shows a flowchart that explains a behavior of the image forming apparatus shown in FIGS. 1 and 2.

### DETAILED DESCRIPTION

Hereinafter, an embodiment according to an aspect of the present disclosure will be explained with reference to drawings.

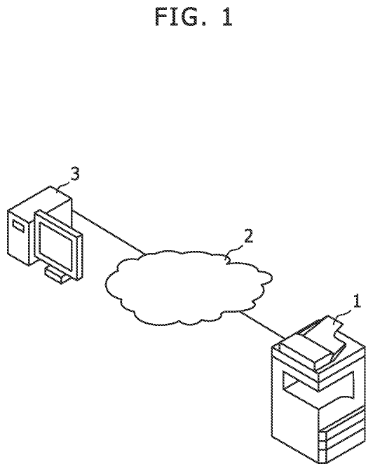

FIG. 1 shows a diagram that indicates a configuration of an image forming system that includes an image forming apparatus according to an embodiment of the present disclosure.

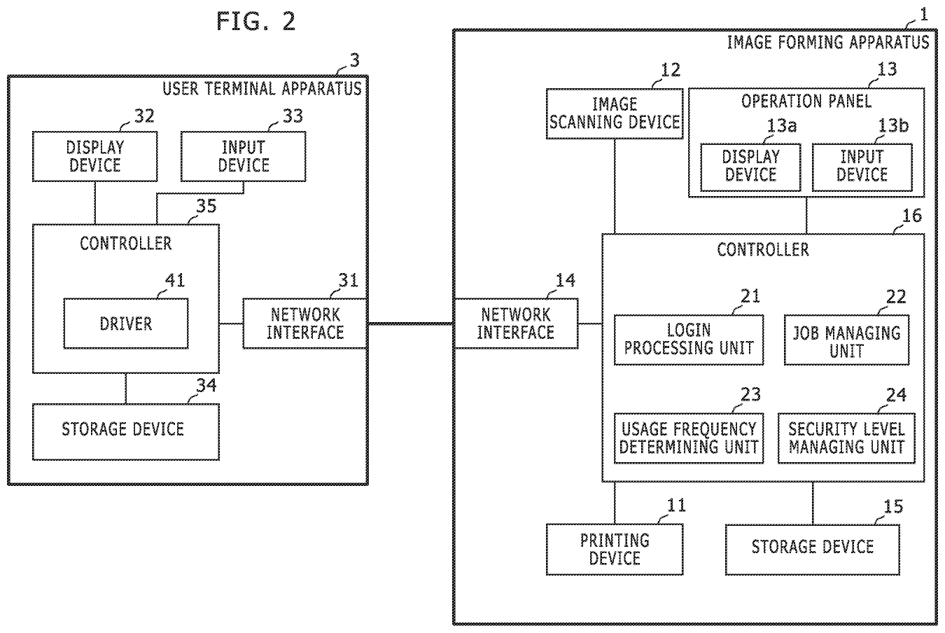

FIG. 2 shows a block diagram that indicates configurations of the image forming apparatus and a user terminal apparatus shown in FIG. 1.

The system shown in FIG. 1 includes an image forming apparatus 1 (e.g. a multi function peripheral, a printer, a copier or the like) available to plural users, and a user terminal apparatus 3 (e.g. a personal computer or the like) that transmits a print job reservation request through a network 2 or the like to the image forming apparatus 1.

As shown in FIG. 2, the image forming apparatus 1 is a multi function peripheral or the like available to plural users, and includes a printing device 11, an image scanning device 12, an operation panel 13, a network interface 14, a storage device 15, and a controller 16.

The printing device 11 is an internal device that prints on a print paper sheet an image specified by the print job request (e.g. in accordance with an electrophotographic printing matter). The image scanning device 12 is an internal device that optically scans a document image of a document and generates image data of the document image.

A print job based on a print job request from the user terminal apparatus 3, the operation panel 13 of the image forming apparatus 1 or the like is performed using the printing device 11. Further, a copy job based on a copy job request the operation panel 13 of the image forming apparatus 1 or the like is performed using the image scanning device 12 and the printing device 11.

The operation panel 13 is arranged on a surface of a housing of the image forming apparatus 1, and includes a display device 13a that displays sorts of messages to a user and an input device 13b that receives a user operation. For example, a liquid crystal display is used as the display device 13a. A hard key, a touch panel and/or the like are/is used as the input device 13b. The operation panel 13 displays an operation screen and the like using the display device 13a, to a user who is physically directly using the image forming apparatus 1, and detects a user operation by the user using the input device 13a.

The network interface 14 is a communication device that is connected to a network 2 such as a wireless LAN (Local Area Network) or a wired LAN, and performs data communication with an external device (the user terminal apparatus 3, an unshown server, or the like) connected to the network 2.

Further, the storage device 15 is a nonvolatile storage device such as a flash memory or a hard disk. In the storage device 15, a program, data and the like required for a process mentioned below have been stored.

Further, in accordance with a job request based on a user operation to the operation panel 13 or a job request received by the network interface 14 from an external device, the controller 16 performs data processing if required, and controls an internal device of the image forming apparatus 1 and thereby performs the requested job (e.g. a print job, a copy job, a facsimile transmission job, or the like). The controller 16 includes a computer that acts as sorts of processing units in accordance with a program. Here, the controller 16 acts as a login processing unit 21, a job managing unit 22, a usage frequency determining unit 23, and a security level managing unit 24.

The login processing unit 21 displays a login screen on the operation panel 13 when the image forming apparatus 1 starts, determines user identification information (e.g. a user ID, a pair of a user ID and a password, or the like) inputted to the login screen on the operation panel 13, and performs a user authentication process for this user on the basis of the user identification information; and if the user authentication for this user succeeded, the login processing unit 21 allows the user to log-in and displays a menu screen for the user to instruct sorts of job requests, and otherwise if the user authentication for this user failed, the login processing unit 21 refuses the user to log-in and continues to display the login screen. Further, when the user performs a logout operation after logging-in, the login processing unit 21 displays the login screen again. The login processing unit 21 may perform the aforementioned user authentication on the basis of user registration data (user identification information, property information and/or the like of registered users) stored in this image forming apparatus 1, or using the network interface 14, may access an external authentication server that manages user registration data and perform the aforementioned user authentication using the authentication server. Further, if the login processing unit 21 allows the user to log-in, the login processing unit 21 records it into an access log that a user access to the image forming apparatus 1 occurs.

The job managing unit 22 receives a job request from the operation panel 13 or an external device such as the user terminal apparatus 3, and performs a job specified by the job request using an internal device (the printing device 11 or the like). Further, if the job managing unit 22 receives a job request through a network from an external device such as the user terminal apparatus 3, the job managing unit 22 records it to the access log that a user access to the image forming apparatus 1 occurs. The access log is stored in a rewritable non-volatile storage medium such as the storage device 15.

The usage frequency determining unit 23 reads the aforementioned access log and determines usage frequencies of respective time zones on the basis of the access log. The time zones are set with a time length of one hour for example, in each day of week. For example, the usage frequency determining unit 23 periodically (e.g. once a day, once a week or the like) determines usage frequencies of the respective time zones on the basis of the access log of users to this image forming apparatus.

The security level managing unit 24 periodically determines security levels of the respective time zones on the basis of the periodically-determined usage frequencies and automatically renews the security level of each of the time zones when the time zone comes. For example, every time that the usage frequency determining unit 23 periodically determines the usage frequencies, the security level managing unit 24 determines security levels of the respective time zones on the basis of the usage frequencies and automatically renews the security levels.

In this embodiment, the security level can be set as any of four levels: 0, 1, 2, and 3, for example; and security setting items such as on/off of administrator authentication, on/off of illegal copy protection, on/off of encryption of an address book, and on/off of usage restriction of a network port are set collectively in accordance with the security level, such that the higher the security level is, the lower the security risk gets.

Here, the security level managing unit 24 sets the higher security level for the lower usage frequency. In this embodiment, the security level managing unit 24 sets the security level as a largest value for the time zone of which the usage frequency is less than a predetermined threshold value, and sets the security level as a default level (for example, a security level specified by a specific user) for the time zone of which the usage frequency is equal to or larger than the predetermined threshold value.

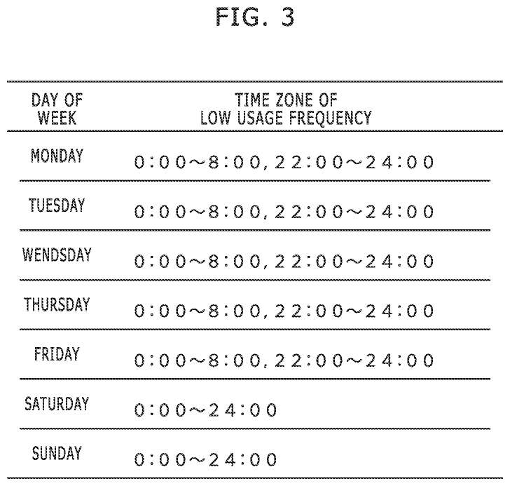

FIG. 3 shows a diagram that indicates an example of a time zone with a low usage frequency on days of week. As shown in FIG. 3 for example, a time zone with a low usage frequency on days of week is determined, and a security level of the time zone with the low usage frequency is set as the largest value.

Meanwhile, as shown in FIG. 2, the user terminal apparatus 3 includes a network interface 31, a display device 32, an input device 33, a storage device 34, a controller 35, and the like.

The network interface 31 is a network interface for a wireless LAN, a wired LAN or the like. The display device 32 is an internal device such as a liquid crystal display, that displays an operation screen and the like for a user. The input device 33 is an internal device such as a touch panel or a key board, that detects a user operation. The display device 32 and the input device 33 may be external devices connected to the user terminal apparatus 3. The storage device 34 is a nonvolatile storage device such as a flash memory and stores a program and data.

The controller 35 controls an internal device in the user terminal apparatus 3 and performs sorts of data processes. The controller 35 includes a computer and executes sorts of programs using the computer, and thereby acts as sorts of processing units. Here the controller 35 acts as a driver 41 for the image forming apparatus 1. The driver 41 determines a print setting and an image to be printed (i.e. image data) in accordance with a user operation to the input device 33, generates a print job request that specifies the print setting and the image to be printed, and transmits the print job request using the network interface 31 to the image forming apparatus 1.

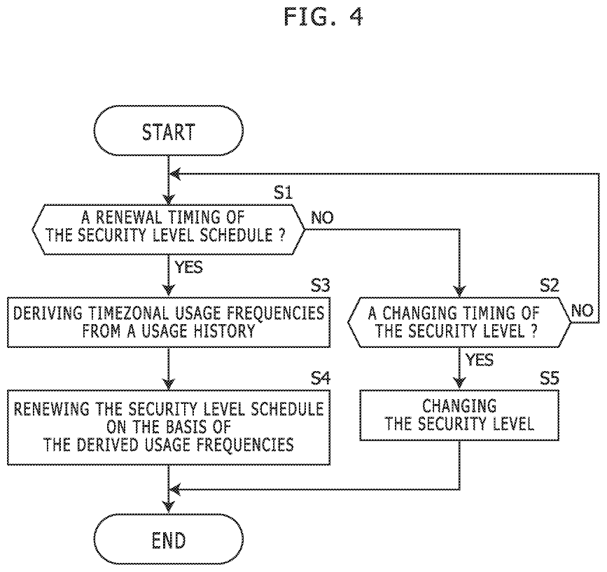

The following part explains a behavior of the aforementioned image forming apparatus 1. FIG. 4 shows a flowchart that explains a behavior of the image forming apparatus shown in FIGS. 1 and 2.

After the image forming apparatus 1 starts, when a user access to the image forming apparatus 1 is detected, it is recorded into the access log, as mentioned.

Further, after image forming apparatus 1 starts, the usage frequency determining unit 23 and the security level managing unit 24 watch whether a renewal timing of a security level schedule comes or not (in Step S1) and watch whether a changing timing of the security levels based on the security level schedule comes or not (in Step S2).

The security level schedule indicates setting values of security levels of respective time zones and respective days of week. On the basis of it, the changing timing of the security levels (i.e. a time point that the security levels are changed) is determined.

When the renewal timing of the security level schedule comes, the usage frequency determining unit 23 determines usage frequencies of the respective time zone on the basis of the access log of users who access this image forming apparatus 1 (in Step S3); and the security level managing unit 24 determines security levels of the respective time zones (i.e. the security level schedule) on the basis of the usage frequencies of the respective time zones determined by the usage frequency determining unit 23, and renews the current security level schedule with the determined security level schedule (in Step S4).

Meanwhile, when the changing timing of the security levels based on the security level schedule comes, the security level managing unit 24 changes the current security levels to security levels specified in the security level schedule (in Step S5).

As mentioned, in the aforementioned embodiment, the usage frequency determining unit 23 periodically determines usage frequencies of time zones on the basis of an access log of users to this image forming apparatus 1. The security level managing unit 24 determines security levels of the respective time zones on the basis of the usage frequencies, and automatically sets the determined security level of each of the time zones when the time zone comes. Further, the security level managing unit 24 sets the higher security level for the lower usage frequency.

Consequently, in accordance with a situation, the security levels are set so as to be suitable to security risk and usability, and therefore, security risk of a time zone that a user does not often use the image forming apparatus gets low without large usability degradation.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, a single threshold value is used to classify the time zones into time zones of low usage frequencies and other time zones. Alternatively, two or more threshold values may be used to classify the time zones into three or more usage frequency classes and determine the security level as any of three or more security levels corresponding to the usage frequency classes.

What is claimed is:

1. An image forming apparatus, comprising:
a usage frequency determining unit configured to determine usage frequencies of respective time zones on the basis of an access log of users to this image forming apparatus; and
a security level managing unit configured to determine security levels of the respective time zones on the basis of the usage frequencies, and automatically set the determined security level of each of the time zones when the time zone comes;
wherein the security level managing unit sets the higher security level for the lower usage frequency.

2. The image forming apparatus according to claim 1, wherein the security level managing unit sets the security level as a largest value for the time zone of which the usage frequency is less than a predetermined threshold value, and sets the security level as a default level for the time zone of which the usage frequency is equal to or larger than the predetermined threshold value.

3. The image forming apparatus according to claim 1, wherein the usage frequency determining unit periodically determines usage frequencies of time zones on the basis of an access log of users to this image forming apparatus; and
the security level managing unit periodically determines security levels of the time zones on the basis of the periodically-determined usage frequencies and automatically renews the security levels.
